(19) United States
(12) Patent Application Publication
(10) Pub. No.: US 2014/0311263 A1
(43) Pub. Date: Oct. 23, 2014

(54) WORM AND WHEEL POWER STEERING GEARBOX

(71) Applicant: FORD GLOBAL TECHNOLOGIES, LLC, Dearborn, MI (US)

(72) Inventors: Joseph Washnock, Canton, MI (US); Jackson E. Barry, JR., Dearborn, MI (US)

(73) Assignee: FORD GLOBAL TECHNOLOGIES, LLC, Dearborn, MI (US)

(21) Appl. No.: 13/864,519

(22) Filed: Apr. 17, 2013

(51) Int. Cl. B62D 3/08

(52) U.S. Cl. CPC B62D 3/08
USPC 74/89.23; 74/89.14

(57) ABSTRACT

A power assist steering system utilizing a steering gearbox with a worm-screw to gear-segment transition from a steering-wheel shaft to a sector shaft and a worm-screw to worm-wheel transition from a power-assist shaft to the steering-wheel shaft. The worm-screw and worm-wheel combination for the power-assist shaft to the steering-wheel shaft may be replaced with a ballnut worm-screw and a ball-track worm-wheel. The system provides for an additional amount of 800 watts or more of power to be made available at the sector shaft with 1600 watts or less of power being made available at the power-assist shaft.

### TECHNICAL FIELD

This disclosure relates to an electronic power assist steering gearbox and specifically to a gearbox having a worm-screw to worm-wheel connection from the power-assist shaft to the steering-wheel shaft and a worm-screw to gear-segment connection from the steering-wheel shaft to the sector shaft.

### BACKGROUND

Typical power steering systems have used rack and pinion or recirculating ball gearbox designs to transfer a rotation of a steering wheel into a turning of wheels of a vehicle. A rack and pinion is a type of linear actuator that comprises a pair of gears which convert rotational motion into linear motion. A circular gear (pinion) is located on a steering-wheel input shaft and engages teeth on a linear gear bar (rack). Rotational motion applied to the steering-wheel causes the pinion to rotate. The rotating pinion causes the rack to move transversely across the vehicle. The rack is connected to a steering knuckle of a wheel-end assembly by a tie-rod. The tie-rod is connected to the knuckle offset from the steering knuckle's turning axis. Transverse movement of the tie-rod causes the knuckle to turn on its turning axis and turn the wheels, thereby translating the rotational motion of the steering-wheel into a turning motion of the wheels of the vehicle.

A recirculating ball steering mechanism has an external thread on a steering-wheel shaft disposed within a block having an internal thread. The internal and external threads are separated by a number of recirculating ball bearings. The block is rotationally restrained while being able to slide linearly, so when the steering-wheel is turned, the external thread rotates and the block moves linearly like a nut moving along a bolt. The block has a set of gear teeth cut into its outside to engage a partial-gear on a sector shaft. The linear movement of the block causes a rotational movement of the sector shaft. The sector shaft moves a pitman arm which is connected to a center link. The center link moves transversely across the vehicle similarly to the rack. Tie-rods are connected between the center link and knuckles to turn the wheels.

Power steering helps drivers steer vehicles by augmenting steering effort of the steering wheel. Hydraulic or electric actuators add controlled energy to the steering mechanism, to reduce the necessary effort than the steering would normally require. Power steering helps considerably when a vehicle is stopped or moving slowly.

Rack and pinion and recirculating ball gearbox designs have a number of interacting moving parts. Rack and pinion and recirculating ball gearbox designs also require a considerable amount of packaging space within the vehicle. These shortcomings are addressed by this disclosure as summarized below.

### SUMMARY

One aspect of this disclosure is directed to a power-steering system having a lower number of moving parts than a rack and pinion or reciprocating ball system. The power-steering system has a steering-wheel shaft with a first worm-screw and a worm-wheel, both coaxially disposed on and connected to the steering-wheel shaft. The system has a power-assist shaft with a second worm-screw coaxially disposed and connected to the power-assist shaft. The worm-screw on the power-assist shaft is in engagement with the worm-wheel on the steering-wheel shaft. This allows for additional steering power to be supplied to the system by an actuator that may be attached to the power-assist shaft. The system also has a sector shaft with a gear-segment disposed on and connected to the sector shaft. The gear-segment on the sector shaft is in engagement with the first worm-screw on the steering-wheel shaft.

The second worm-screw on the power-assist shaft may be a ballnut worm-screw and the worm-wheel on the steering-wheel shaft may be a ball-track worm-wheel. A ballnut worm-screw may define a helical channel around an outer surface with a number of balls filling the channel. An internal channel may pass between the two ends of the channel to provide a looped path for the balls to travel around. One of the balls in the helical channel may be in contact with the ball-track worm-wheel. The ball acts as a bearing reducing friction forces between the two components while maintaining direct contact with each component.

The first worm-screw and gear-segment engagement, second worm-screw and worm-wheel engagement, and respective portions of the steering-wheel, power-assist, and sector shafts may all be located within a housing. This housing, and the aforementioned components housed within, may provide a steering gearbox having less moving parts and taking up less packing space within a vehicle as compared to the rack and pinion or recirculating ball designs.

Another aspect of this disclosure is directed to a power assisted steering gearbox. The gearbox has a housing surrounding a portion of a steering-wheel shaft which is in rotational connection with the steering-wheel. The steering-wheel shaft is connected to a sector shaft within the housing, and a portion of the sector shaft exits the housing to be connected to other steering system components that turn the wheels. The steering-wheel shaft has a first worm-screw coupled with a gear-segment disposed on the sector shaft. Rotation of the steering-wheel shaft rotates the first worm-screw feeding teeth of the gear-segment up or down the screw. The teeth on the gear-segment are offset from an axis of rotation of the sector shaft and the movement of the teeth in the screw pivots the sector shaft on its axis. A portion of a power-assist shaft comes into the housing and has a second worm-screw coupled to a worm-wheel disposed on the steering-wheel shaft as well. Power from the power-assist shaft is transmitted to the sector shaft through the steering-wheel shaft via the second worm-screw and worm-wheel and first worm-screw and gear-segment couplings, respectively.

The second worm-screw and worm-wheel coupling may be a ballnut worm-screw and ball-track worm-wheel coupling. The ballnut worm-screw and ball-track worm-wheel may share a plurality of balls that provide contact between the two. The balls may reduce friction between the two components while allowing for better contact between the two improving the gear efficiency.

A further aspect of this disclosure is directed to a power assisted steering apparatus. The apparatus has a power-assist shaft having a worm-screw defining a helical channel with a number of freely moving balls partially disposed therein. The apparatus also has a steering-wheel shaft having a worm-wheel defining a number of ball-receiving indentations along its perimeter. Power from the power-assist shaft is transferred from the worm-screw to the worm-wheel by at least one of the balls being codisposed in the helical channel and one of the ball-receiving indentations. The ball provides for a lower friction contact as the worm-screw and worm-wheel rotate about each other while also providing good surface contact between the two components.

The worm-screw may define an internal channel connected between a proximal end and a distal end of the helical channel. The internal channel may provide a path for the balls to travel around the helical channel and from the proximal end to the distal end. The helical channel may be partial-circular with a semicircular base and a gothic arches extending from each side of the semicircular base. The gothic arches partially surround the balls in the helical channel retaining them within the worm-screw.

A motor may be connected to the power-assist shaft. The power from the motor may be transmitted to the steering-wheel shaft by the at least one of the balls being disposed between the helical channel and one of the ball-receiving indentations. The motor may have a maximum power assist of 1600 watts. A sector shaft may be connected to the steering-wheel shaft via a gear set combination, and the power-assist shaft may provide assisting power to the steering-wheel shaft to assist in rotating the sector shaft to turn wheels on a vehicle in response to a driver turning a steering-wheel.

The above aspects of this disclosure and other aspects will be explained in greater detail below with reference to the attached drawings.

### BRIEF DESCRIPTION OF THE DRAWINGS

FIG. 1 is a diagrammatic view of a power assist steering system.

FIG. 2 is a perspective cut-away view of a worm and wheel power steering gearbox.

FIG. 3 is a top view of a sector shaft with a gear-segment and a power-assist shaft with a worm-screw coupled with a respective worm-screw and worm-wheel on a steering-wheel shaft.

FIG. 4 is a partial side view of a worm-screw on a power-assist shaft coupled with a worm-wheel on a steering-wheel shaft.

FIG. 5 is a partial side view of a ballnut worm-screw on a power-assist shaft coupled with a ball-track worm-wheel on a steering-wheel shaft.

FIG. 6 is a partial side view of a ballnut worm-screw with most of the balls removed.

FIG. 7 is a cross-sectional view of ballnut worm-screw.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

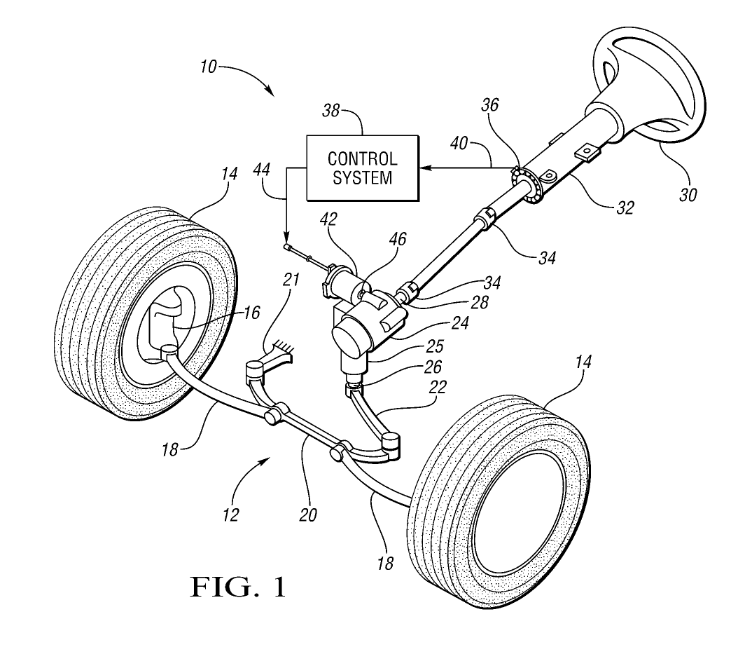

FIG. 1 shows a power steering system 10 connected to a parallelogram steering architecture 12, although other steering architectures may be used. Wheels 14 are mounted on pivotable steering-knuckles 16 that are connected to a vehicle (not shown). Steering-knuckles 16 may be connected to a vehicle's suspension system. Tie-rods 18 are connected to respective steering-knuckles 16 at locations offset from the pivot axis of the steering-knuckle 16 such that linear movement of a tie-rod 18 will pivot the steering-knuckle 16 on its pivot axis. Tie-rods 18 may provide for an adjustable length component to adjust the toe of the vehicle.

A center link 20 runs transversely across the vehicle connecting the tie-rods 18 to each other. The center link 20 and tie-rods 18 create a mechanical link between the turning of the steering-knuckles 16 and the wheels 14. An idler arm 21 connects the center link 20 to a vehicle frame, for example, to provide a fixed boundary condition and pivot for the center link 20. A pitman arm 22 is also connected to the center link 20 and connects the parallelogram steering architecture 12 to a steering gearbox 24.

Gearbox 24 provides a housing 25. A sector shaft 26 extends from the housing 25 and connects to the pitman arm 22. Rotation of the sector shaft 26 swings the pitman arm 22 causing a substantially transverse movement of the center link 20 across the vehicle. As the center link 20 moves, the tie-rods 18 move and pivot the steering-knuckles 16 turning the wheels 14.

The sector shaft 26 is connected to a steering-wheel shaft 28 within the gearbox 24, and the steering-wheel shaft 28 is operatively/mechanically connected to a steering wheel 30. The steering wheel 30 may be part of a steering-column 32 and may be provided with a number of links 34, shown as constant velocity joints 34, that allow the steering-wheel shaft 28 to be packaged and routed within the vehicle.

The steering wheel 30 is mechanically connected to the steering-wheel shaft 28, such that when the steering wheel 30 is rotated about its axis, the steering-wheel shaft 28 rotates about its axis. The rotation of the steering-wheel shaft 28 in turn rotates the sector shaft 26 and pivots the pitman arm 22 turning the wheels 14. As the steering wheel 30 is rotated, a sensor 36 such as a steering angle sensor 36, may detect the rotation. A controller 38 may be in communication with sensor 36, as indicated by communication line 40, and an actuator 42, as indicated by communication line 44. The actuator 42 may be connected to the gearbox 24 via a power-assist shaft 46 and capable of providing additional power to aid in the rotation of the sector shaft 26. The controller 38 may take into account additional inputs such as vehicle speed, and when the controller 38 identifies a steering input by utilizing the sensor 36, the controller 38 may actuate the actuator 42 to provide power assist during the steering of the vehicle.

Actuator 42 is connected to the power-assist shaft 46 and is capable of rotating the power-assist shaft 46. The actuator 42 may be an electric motor, although other actuators may be used. Design considerations may be put into place to provide a gearbox 24 as small as possible to limit the amount of packaging space the gearbox 24 requires within the vehicle. Similarly design considerations may be put into place to limit the size of the actuator 42 used with the system 10. Actuator 42 may be sized to provide a maximum power output of 1600 watts of power to the power-assist shaft 46, although actuators may be used that provide greater or lesser power. The gearbox 24 may be designed so as to provide at least 800 watts of power at the sector shaft 26 in response to a maximum power input of 1600 watts being applied to the power-assist shaft 46.

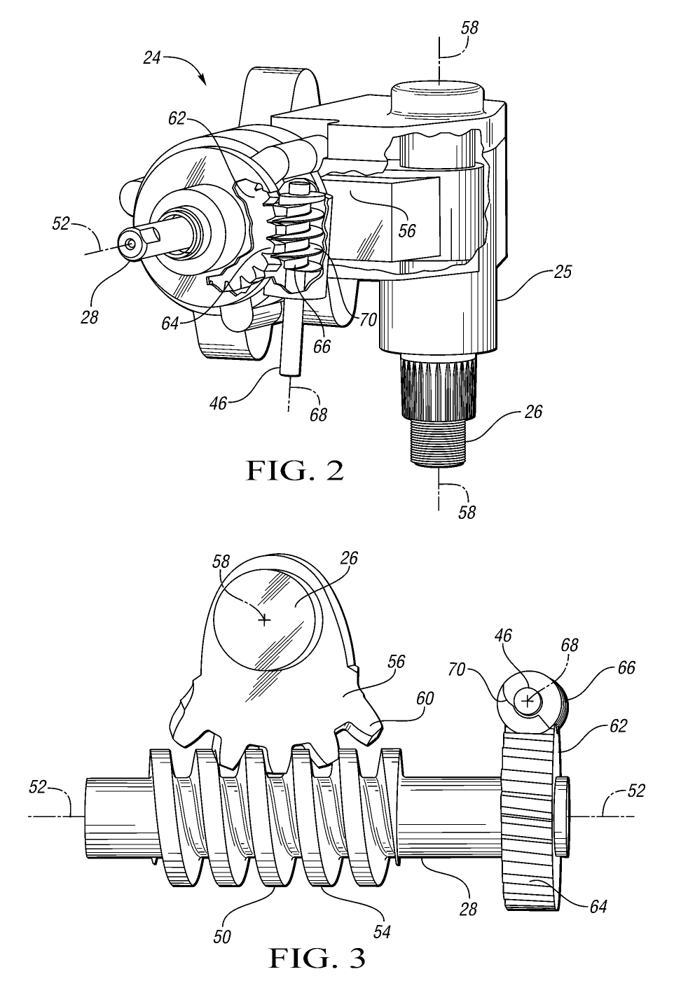

FIG. 2 shows a gearbox 24 with the housing 25 cut-away exposing some of the internal components. Portions of the steering-wheel shaft 28, power-assist shaft 46, and sector shaft 26 are shown disposed within and extending from the housing 25. The steering-wheel shaft 28, power-assist shaft 46, and sector shaft 26, as shown, may be connected to the surrounding steering system componentry as shown in FIG. 1. FIG. 3 shows a top view of the steering-wheel shaft 28, power-assist shaft 46, and sector shaft 26 as disposed within the housing 25 of gearbox 24 in FIG. 2.

Referring to FIGS. 2 and 3, the steering-wheel shaft 28 has a first worm-screw 50 coaxially disposed thereon. The first worm-screw 50 is rotationally fixed to the steering-wheel shaft 28 sharing the same axis of rotation 52. The first worm-screw 50 has a first helical thread 54 running down the periphery of the steering-wheel shaft 28.

The sector shaft 26 has a gear-segment 56 connected to an upper region of the sector shaft 26. The gear-segment 56 is pivotally fixed to the sector shaft 26 and both share a pivot axis 58. The gear-segment 56 has a first set of teeth 60 with at least one tooth 60 engaged with grooves in the the first helical thread 54 of the first worm-screw 50. The gear-segment 56 is coupled to the first worm-screw 50 such that when the steering-wheel shaft 28 rotates, the first worm-screw 50 rotates and the first set of teeth 60 of the gear-segment 56 are moved along the first helical thread 54 causing the gear-segment 56 and the sector shaft 26 to rotate about pivot axis 58.

The steering-wheel shaft 28 also has a worm-wheel 62 coaxially disposed thereon. The worm-wheel 62 is rotationally fixed to the steering-wheel shaft 28 sharing the same axis of rotation 52 as the first worm-screw 50. The worm-wheel 62 has a second set of teeth 64. The power-assist shaft 46 has a second worm-screw 66 coaxially disposed thereon. The second worm-screw 66 is rotationally fixed to the power-assist shaft 46 sharing the same axis of rotation 68. The second worm-screw 64 has a second helical thread 70 about the periphery of the power-assist shaft 46.

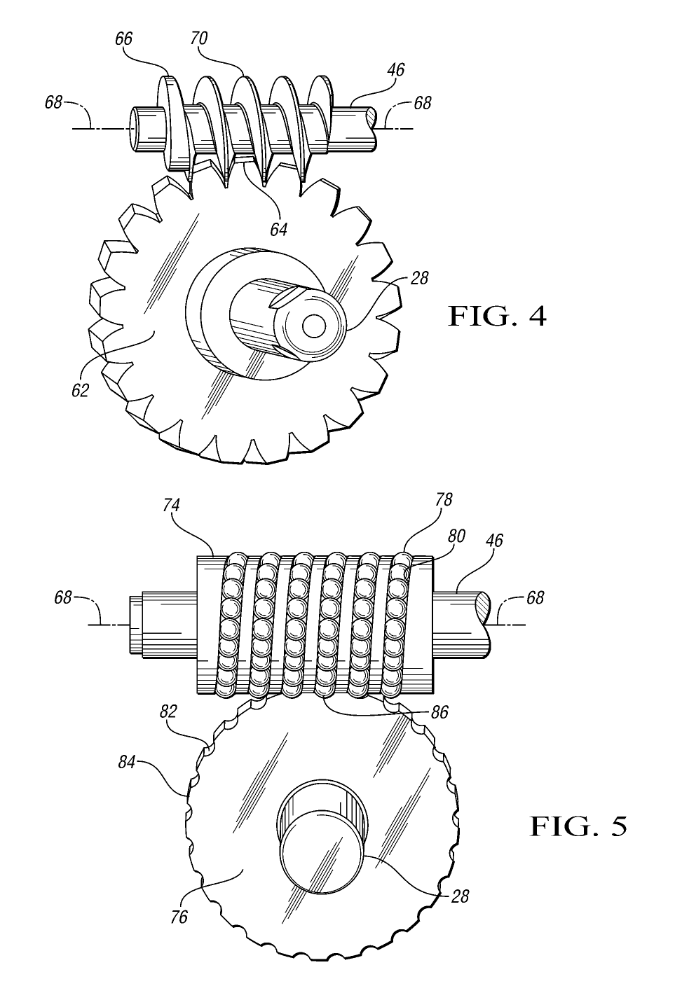

FIG. 4 shows a partial side view of the second worm-screw 66 of the power-assist shaft 46 having the second helical thread 70 engaged with at least one tooth 64 from the second set of teeth 64 of the worm-wheel 62 on the steering-wheel shaft 28. Power applied to the power-assist shaft 46 rotates the power-assist shaft 46 rotating the second worm-screw 66. The second helical thread 70 feeds the second set of teeth 64 on the worm-wheel 62, rotating the worm-wheel 62. Rotation of the worm-wheel 62 in turn rotates the steering-wheel shaft 28 and subsequently the sector shaft 26 as described above.

Referring to FIGS. 2-4, power applied to the power-assist shaft 46 may be transmitted through the gearbox 24 to the sector shaft 26. Gearbox 24 may be capable of providing at least 800 watts of power at the sector shaft 26 in response to a maximum power of 1600 watts being applied to the power-assist shaft 46. A clutch (not shown) may also be disposed between the power-assist shaft 46 and the actuator 42, such that the power-assist shaft 46 may rotate freely when no power-assist is being applied.

Gearbox 24 provides the first worm-screw 50 and gear-segment 56 engagement, second worm-screw 66 and worm-wheel 62 engagement, and respective portions of the steering-wheel shaft 28, power-assist shaft 46, and sector shaft Gearbox 24 provides a design with a lower number of interacting moving parts as compared to a rack and pinion and recirculating ball gearbox designs. Gearbox 24 also requires less packaging space within the vehicle than the rack and pinion and recirculating ball gearbox designs.

In an alternate embodiment, the second worm-screw 66 on the power-assist shaft 46 and the worm-wheel 62 on the steering-wheel shaft 28 may be replaced with a ballnut worm-screw 74 and a ball-track worm-wheel 76. The bullnut worm-screw 74 and ball-track worm-wheel 76 may further improve the efficiency of the system allowing for a smaller gearbox 24 and or actuator 42.

Referring to FIGS. 5, a ballnut worm-screw 74 is shown with a plurality of balls 78 partially disposed within and around a helical channel 80. The balls of the ballnut worm-screw 74 engage a number of equally spaced concaved ball-receiving indentations 82 defined along an outer circumference surface 84 of a ball-track worm-wheel 76. At least one ball 86 is codisposed in the helical channel 80 and one of the ball-receiving indentations 82. As the power-assist shaft 46 is rotated, the at least one codisposed ball 86 is moved with the helical channel 80 in a direction along the axis 68 of the power-assist shaft 46. The indentation 82 with the codisposed ball 86 is rotated as the codisposed ball 86 follows the helical channel 80. The rotation of the indentation 82 rotates the ball-track worm-wheel and steering-wheel shaft 28. The rotation of the ball-track worm-wheel 76 aligns an adjacent indentation 82 to align with another ball of the plurality of balls 78 and the process repeats.

The ballnut worm-screw 74 and ball-track worm-wheel share the plurality of balls 78 that provide contact between the two components. The balls 78 provide a bearing between the worm-screw 74 and worm-wheel 76 reducing friction and increasing surface area to transfer the power. The balls 78 space the ballnut worm-screw 74 and ball-track worm-wheel 76 away from each other so that they do not contact each other. The codisposed ball 86 will roll between the two contact surfaces of the ballnut worm-screw 74 and ball-track worm-wheel 76. The rolling of the codisposed ball 86 provides for a substantially static friction contact between the codisposed ball 86 and each surface, much like a tire rolling on the ground, resulting in little to no dynamic friction between the worm-screw and worm-wheel.

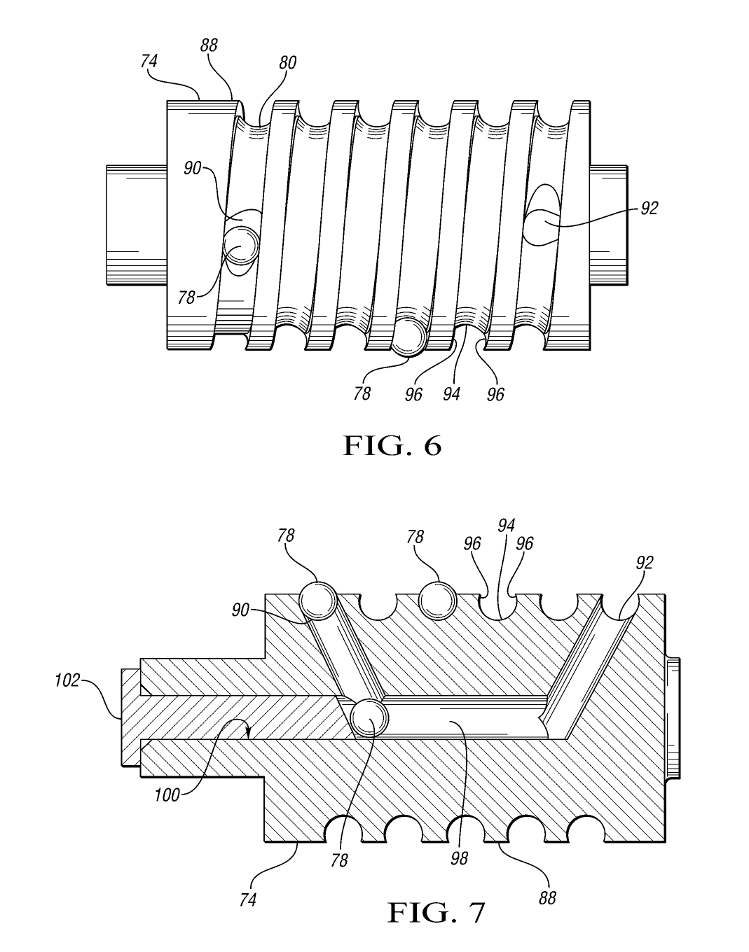

Referring to FIGS. 6 and 7, the ballnut worm-screw 74 is shown with most of the balls 78 removed. The ballnut worm-screw 74 has an outer surface 88 and the helical channel 80 may be defined within the outer surface 88 of the ballnut worm-screw 74. The helical channel 80 has a proximal end 90 and a distal end 92. The helical channel 80 is partial-circular and wraps around a portion the plurality of balls 78 retaining the balls 78 on the ballnut worm-screw 74. A cross-section of the helical channel 80 may have a depth greater than the radius of the balls 78, but lesser than the diameter of the balls 78 to allow for the balls 78 to protrude from the surface 88 of the ballnut worm-screw 74 and be codisposed within a ball-receiving indentation 82 on a ball-track worm-wheel 76 (see FIG. 5). The partial-circular shape comprises a semicircular base 94 with gothic arches 96 extending from each edge of the semicircular base 94. A cross-sectional distance between opposing gothic arches 96 may be smaller than the diameter of the balls 78 such that the balls 78 may not pass radially outward from the helical channel 80. A cross-sectional diameter of the helical channel 80 may be larger than the diameter of the balls 78 allowing the balls 78 to slide and roll around the helical channel 80 to and from the proximal and distal ends 90, 92.

The ballnut worm-screw 74 also has an internal channel 98 connecting the proximal end 90 to the distal end 92 of the helical channel 80. The internal channel 98 passes axially through the ballnut worm-screw 74. The internal channel 98 provides a looped path for the plurality of balls 78 to travel through the internal channel 98 and around the helical channel 80 from the proximal end 90 to the distal end 92 and vice versa. The internal channel 98 may also being in communication with a ball-loading chute 100. The plurality of balls 78 may be loaded into the ballnut worm-screw 74 through the ball-loading chute 100, filling the internal channel 98 and the helical channel 80 with the plurality of balls 78. Once the ballnut worm-screw 74 is full of balls 78, a cap 102 may be disposed in the ball-loading chute 100 to retain the plurality of balls 78 in the ballnut worm-screw 74.

The ballnut worm-screw 74 and ball-track worm-wheel 76 (see FIG. 5) provides assisting power from an actuator 42 to be transmitted from a power-assist shaft 46 to a steering-wheel shaft 28, increasing the power being delivered to a sector shaft 26. The actuator 42 may receive a signal 44 from a controller 38 to provide assisting power when a driver turns a steering wheel 30 on the vehicle. The ballnut worm-screw 74 and ball-track worm-wheel 76 provide a highly efficient gear set that allows for a smaller actuator to be used to provide the same amount of power assistance. The above combination of gearings may allow for 800 watts or more of additional power to be made available at the sector shaft 26 using an actuator 42 with a maximum power assistance of 1600 watts or less.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A power-steering system comprising:
a steering-wheel shaft having a first worm-screw and a worm-wheel coaxially disposed thereon;
a power-assist shaft having a second worm-screw coaxially disposed thereon in engagement with the worm-wheel; and
a sector shaft having a gear-segment in engagement with the first worm-screw.

2. The system of claim 1 wherein the second worm-screw is a ballnut worm-screw and the worm-wheel is a ball-track worm-wheel.

3. The system of claim 2 wherein the ballnut worm-screw defines a helical channel around an outer surface, and the ballnut worm-screw further comprises a plurality of balls partially disposed in the helical channel.

4. The system of claim 3 wherein the helical channel has a proximal end and a distal end and the ballnut worm-screw defines an internal channel passing therethrough connecting the proximal and distal ends providing a looped path for the plurality of balls to travel through the helical channel and through the internal channel from the proximal end to the distal end.

5. The system of claim 3 wherein the helical channel is partial-circular with a semicircular base and a gothic arch extending from each edge of the semicircular base that partially surrounds the plurality of balls partially disposed in the helical channel retaining the plurality of balls within the helical channel.

6. The system of claim 3 wherein at least one of the plurality of balls partially disposed in the helical channel is in contact with the ball-track worm-wheel.

7. The system of claim 3 wherein the ball-track worm-wheel defines a number of equally spaced concaved ball-receiving indentations along an outer circumference of the ball-track worm-wheel and wherein at least one of the plurality of balls is a partially disposed in at least one indentation.

8. The system of claim 1 further comprising an actuator attached to the power-assist shaft.

9. The system of claim 8 wherein the actuator provides a maximum power output of 1600 watts of power to the power-assist shaft.

10. The system of claim 9 wherein the sector shaft is capable of outputing at least 800 watts of power in response to the actuator proving a maximum power output of 1600 watts of power to the power-assist shaft.

11. The system of claim 1 further comprising a housing wherein the first worm-screw and gear-segment engagement, second worm-screw and worm-wheel engagement, and respective portions of the steering-wheel, power-assist, and sector shafts are at least partially disposed therein.

12. A power assisted steering gearbox comprising:
a housing at least partially surrounding a steering-wheel shaft having a first worm-screw coupled with a gear-segment disposed on a sector shaft, and a power-assist shaft having a second worm-screw coupled with a worm-wheel disposed on the steering-wheel shaft, wherein power applied to the power-assist shaft is transmitted to the sector shaft through the steering-wheel shaft via the second worm-screw and worm-wheel and first worm-screw and gear-segment couplings, respectively.

13. The gearbox of claim 12 wherein the second worm-screw and worm-wheel coupling is a ballnut worm-screw and ball-track worm-wheel coupling, wherein the ballnut worm-screw and ball-track worm-wheel share a plurality of balls that provide contact between the two.

14. The gearbox of claim 12 wherein the sector shaft is capable of providing a power output equal to or greater than 800 watts in response to the power-assist shaft receiving a power input of 1600 watts or less.

15. A power assisted steering apparatus comprising:
a power-assist shaft having a worm-screw defining a helical channel with a plurality of balls partially disposed therein; and
a steering-wheel shaft having a worm-wheel defining a number of ball-receiving indentations, wherein at least one of the plurality of balls is at least partially codisposed in the helical channel and one of the ball-receiving indentations transferring power assist to the steering-wheel shaft from the power-assist shaft.

16. The apparatus of claim 15 wherein the worm-screw defines an internal channel connected to a proximal end and a distal end of the helical channel and passing axially therethrough providing a path for the plurality of balls to travel around the helical channel and from the proximal end to the distal end of the helical channel through the internal channel.

17. The apparatus of claim 15 wherein the helical channel is partial-circular with a semicircular base and gothic arches extending from each side of the semicircular base that partially surround the plurality of balls in the helical channel retaining the plurality of balls within the worm-screw.

18. The apparatus of claim 15 further comprising a motor connected to and capable of rotating the power-assist shaft, wherein power from the motor is transmitted to the steering-wheel shaft by the at least one of the plurality of balls being at least partially codisposed in the helical channel and one of the ball-receiving indentations.

19. The apparatus of claim 18 wherein the motor has a maximum power assist of 1600 watts.

20. The apparatus of claim 15 further comprising a sector shaft connected to the steering-wheel shaft via a gear set combination, and the power-assist shaft provides assisting power to the steering-wheel shaft to assist in rotating the sector shaft to turn wheels on a vehicle in response to a driver turning a steering-wheel.
